(19) United States
(12) Patent Application Publication
(10) Pub. No.: US 2020/0399131 A1
(43) Pub. Date: Dec. 24, 2020

(54) A METHOD OF FORMING POROUS GRAPHENE-BASED STRUCTURES

(71) Applicant: ROYAL MELBOURNE INSTITUTE OF TECHNOLOGY, Melbourne, Victoria (AU)

(72) Inventors: Litty Varghese Thekkekara, Melbourne, Victoria (AU); Min Gu, Melbourne, Victoria (AU); Xi Chen, Melbourne, Victoria (AU)

(21) Appl. No.: 16/979,301

(22) PCT Filed: Mar. 8, 2019
(86) PCT No.: PCT/AU2019/050214

§ 371 Date: Sep. 9, 2020

(30) Foreign Application Priority Data
Mar. 9, 2018 (AU) 2018900781

(51) Int. Cl. C01B 32/192; C01B 32/198; B32B 9/00

(52) U.S. Cl. CPC C01B 32/192; B82Y 30/00; B32B 9/007; C01B 32/198

(57) ABSTRACT

A method of forming a porous graphene-based structure, including directing a laser beam onto one or more layers of graphene oxide to reduce at least a portion of the graphene oxide, wherein the laser beam consists of ultrafast femtosecond (fs) pulses of laser radiation to cause reduction of at least a portion of the graphene oxide by two-photon absorption and form one or more respective porous layers of reduced graphene oxide (rGO) having substantially uniform porosity. In some embodiments, the photoreduction of graphene oxide using the femtosecond laser beam is influenced by acoustic waves in addition to two-photon absorption.

### TECHNICAL FIELD

The present invention relates to a method of forming porous graphene-based materials and structures for a variety of applications, including sensing and energy storage (such as supercapacitors), for example.

### BACKGROUND

Graphene based materials and structures have become increasingly important subjects of research for use in a wide variety of different advanced applications, including telecommunications, biomedical applications, free-form optics, and displays.

Additionally, the ubiquity of portable electronic devices has increased the need to develop small and lightweight energy storage materials and devices with high energy densities and power delivery capabilities. Although there are reports in the literature of two-dimensional energy storage devices such as supercapacitors formed from graphene-based materials, the performance of these devices has been disappointing, providing, for example, very limited areal capacitance. In order to address this difficulty, three-dimensional structures have been explored to some degree. However, to date the research in this promising area has been limited to the use of pseudo-capacitive materials and gold nanoparticles in laser-scribed graphene.

It is desired, therefore, to overcome or alleviate one or more difficulties of the prior art, or to at least provide a useful alternative.

### SUMMARY

In accordance with some embodiments of the present invention, there is provided a method of forming a porous graphene-based structure, including directing a laser beam onto one or more layers of graphene oxide to reduce at least a portion of the graphene oxide, wherein the laser beam consists of ultrafast femtosecond (fs) pulses of laser radiation to cause reduction of at least a portion of the graphene oxide by two-photon absorption and form one or more respective porous layers of reduced graphene oxide (rGO) having substantially uniform porosity. In some embodiments, the photoreduction of GOs using the femtosecond laser beam is influenced by acoustic waves in addition to two-photon absorption.

In some embodiments, the one or more layers are a plurality of layers.

In some embodiments, the reduction of the graphene oxide at least partially includes at least one of a photothermal effect and a photochemical effect. The two-photon absorption may induce the photothermal effect. In some embodiments, the photochemical effect includes a photoacoustic effect. In some embodiments, at least one of the photothermal and the photochemical effect are at least partially tunable using a repetition rate of the pulses.

The resultant graphene-based structure is a porous graphene-based structure. In some embodiments, the porosity is uniform porosity providing a substantially uniform spatial distribution of pores. The uniform porosity may provide a substantially uniform statistical distribution of pore sizes. In some embodiments, the average pore size is less than 60 nm. In some embodiments, the average pore size is less than 50 nm. In some embodiments, the average pore size is less than 40 nm. In some embodiments, the average pore size is less than 30 nm. In some embodiments, the average pore size is less than 20 nm. In some embodiments, the average pore size is less than 15 nm.

In some embodiments, the laser beam has a wavelength of about 800 nm, and the pulses have a width of about 120 fs and a repetition rate of 80 MHz to provide an average power of about 30 mW and a laser fluence of about 0.2 mJ cm⁻².

In some embodiments, the laser beam is directed onto the one or more layers in accordance with a predetermined pattern such that the resulting porous layers are correspondingly patterned.

In some embodiments, the method includes forming a supercapacitor from the structure, wherein the porous layers form electrodes of the supercapacitor.

The supercapacitor may have an energy density of at least 0.1 Wh cm⁻³. The supercapacitor may have a power density of at least 10³W cm⁻³. The supercapacitor may have a volumetric capacitance of about 10² mF cm⁻³.

In some embodiments, the method includes depositing the layers of graphene oxide on a substrate.

In some embodiments, the porous layers are stretchable by at least 10%. In some embodiments, the porous layers are stretchable by at least 50%. In some embodiments, the porous layers are stretchable by at least 100%. In some embodiments, the porous layers are stretchable by at least 150%.

In some embodiments, the substrate is a polymer substrate. In some embodiments, the polymer substrate is a polydimethylsiloxane (PDMS) substrate.

In some embodiments, the one or more layers are a plurality of layers, and the porous layers have a spacing of about 1 μm.

In accordance with some embodiments of the present invention, there is provided a porous structure formed by any one of the above methods.

In accordance with some embodiments of the present invention, there is provided a porous graphene-based structure, including porous layers of reduced graphene oxide (rGO) having substantially uniform porosity. The uniform porosity may provide a substantially uniform spatial distribution of pores. The uniform porosity may provide a substantially uniform statistical distribution of pore sizes. The average pore size may be less than 20 nm, and is preferably less than 15 nm.

### BRIEF DESCRIPTION OF THE DRAWINGS

Some embodiments of the present invention are hereinafter described, by way of example only, with reference to the accompanying drawings, wherein:

FIG. 1 is a flow diagram of a method of forming porous graphene structures in accordance with some embodiments of the present invention;

FIG. 2 is a schematic illustration of porous layers formed by the method of FIG. 1, and the dependence of porosity on the pulsed laser repetition rate;

FIG. 3 includes two scanning electron microscope images showing pores formed by the pulsed laser irradiation for (a) a high repetition rate of 80 MHz, and (b) a lower repetition rate of 10 kHz;

FIG. 4 is a graph showing the statistical distributions of pore sizes resulting from pulsed laser irradiation at frequencies of 10 kHz, 20, 40, and 80 MHz, and (for comparison) a CO₂ laser;

FIG. 5 characterises the decrease in influence of two-photon absorption in the reduction of graphene oxide to rGO as repetition rate of the applied laser pulses decreases, with repetition rates including (a) 80 MHz; (b) 40 MHz; (c) 20 MHz; (d) 10 kHz and (e) 5 kHz;

FIG. 6 includes: (a) a schematic illustration showing thickness reduction of graphene oxide to rGO using ultrashort pulse of laser; (b) a CCD camera image of transient photoacoustic waves in a graphene oxide film during application of ultrashort pulses of laser at repetition rate 5 kHz; and (c) a CCD camera image of the graphene oxide film of example (b) after application of the laser radiation and showing a region of reduced thickness indicating reduced graphene oxide;

FIG. 7 includes: (a) to (h) CCD camera images of transient photoacoustic waves in graphene oxide films during application of ultrashort pulses of laser applied at repetition rate of 5kHz, with increasing laser fluence; and (i) an electron microscope image of a portion of the film of Figure (d), showing portions of the thickness reduction of the rGO thin film formed by photochemical reduction induced by the pulsed laser, and remaining graphene oxide (GO) regions that were not exposed to the laser beam;

FIG. 8 includes: (a) a graph characterising the photoacoustic pressure at different laser fluences and laser scanning speeds at a lower repetition rate (5kHz); and (b) a graph showing the relationship between photoacoustic pressure and number of pulses of laser radiation at laser fluence of 10 μJ/cm2 and laser scanning speed of 10 μm/s;

FIG. 9 characterising the theoretical and experimental relationship between photoacoustic pressure and laser fluence generated at lower laser pulse repetition rates (5 kHz) in GO films of different thickness, using laser pulse wavelength 800 nm, including: (a) a GO film thickness of 3 μm; and (b) a GO film thickness of 5 μm;

FIG. 10 includes a schematic showing an experimental setup for measuring the photoacoustic effect in graphene oxide films upon application of ultrashort pulses of laser radiation;

FIG. 11 includes a graph of the surface temperature of graphene oxide films during photoreduction by ultrashort pulses of laser radiation at different pulse repetition rates and laser fluences;

FIG. 12 shows different rGO thin film characteristics, where the films have been reduced using ultrashort pulses of laser radiation at a wavelength of 800 nm in conjunction with a 1.4 objective, including: (a) electron microscopy images of the rGO films showing decreasing line width with decreasing laser pulse repetition rate 80 MHz, 40 MHz, 20 MHz, 10 kHz, and 5 kHz; (b) electron microscopy images of the rGO films of (a) exhibiting a semimetal state with a polycrystalline behaviour and smaller crystalline phases observable in the diffraction profiles; and (c, d and e) electronic microscopy images of rGO thin films obtained using different laser scanning speeds including 100 μm/s, 500 μm/s, and 1000 μm/s and a laser pulse repetition rate of 80 MHz, showing higher scanning speeds leading to ablation of the film pattern;

FIG. 13 is a graph showing the dependence of electrical conductivity and the sp2/sp3 ratio measured by X-ray photoelectron spectroscopy (XPS) as a function of the pulsed laser repetition rate;

FIG. 14 includes (a) a graph showing the optical bandgap obtained for the rGO film under optimum laser fluence for different pulse repetition rates; and (b) a schematic of the bandgap formation in graphene oxide during two-photon absorption;

FIG. 15 is a schematic illustration of a supercapacitor formed from a stack of porous layers formed by the method of FIG. 1, showing the separation of positive and negative ions in adjacent layers of the stack;

FIG. 16 illustrates the formation of a supercapacitor device in accordance with the method of FIG. 1;

FIG. 17 includes: (i) a micrograph of a porous graphene structure formed by the method of FIG. 1, (ii) a schematic diagram illustrating a stack of patterned porous layers of the structure, (iii) an electron microscope image showing a portion of the stack with residual graphene oxide layers and reduced graphene oxide/graphene layers, and (iv) a higher magnification electron microscope image showing the complex porous structure of the graphene oxide/graphene layers;

FIG. 18 includes four graphs characterising the electrical performance of supercapacitors formed by the method of FIG. 1, showing: (a) the dependence of current density on applied voltage for different voltages scan rates, (b) the volumetric capacitance as a function of scan rate, calculated from the graph of (a), the capacitance retention of the supercapacitors as a function of voltage cycle, and (d) galvanic charge-discharge curves of the supercapacitors at different current densities;

FIG. 19 is a Ragone plot showing the relationship between energy density and power density for different energy storage technologies, including the supercapacitors described herein (Key: LSG-MSC FS-IL: Laser scribed graphene microsupercapacitor, ionogel made of fumed silica and ionic liquid, LIG-MSC in IL: laser induced graphene microsupercapacitor, ionic liquid, BFE-MSC: Ionic gel—bioinspired fractal electrode microsupercapacitor, ionic gel, FIB-rGO: focused ion beam-reduced graphene oxide, LSG-EC: Laser scribed graphene -electrochemical capacitor, GO-MSC: graphene oxide micro-supercapacitors, BFC-MSC: ionic liquid—bioinspired fractal electrode microsupercapacitor, ionic liquid);

FIG. 20 includes: (a) optical microscope images of a stretchable supercapacitor structure and its electrodes in stretched and upstretched configurations, and graphs showing: (b) the volumetric capacitance of the stretchable supercapacitor structures as a function of percentage stretching, (c) the decrease of capacitance as a function of the number of stretches, and (d) the decrease of capacitance as a function of the number of voltage cycles for a stretchable capacitor stretched to 150% of its original length;

FIG. 21 includes schematic illustrations showing a roll to roll laser printer for producing porous graphene structures and how multiple laser beams can be used for simultaneous direct laser reduction of graphene oxide in a single graphene oxide layer, and in different graphene oxide layers; and,

FIGS. 22(a) and 22(b) include a flowchart including an example method for generating a hologram for multifocal fabrication of two-photon induced, patterned regions of reduced graphene oxide.

### DETAILED DESCRIPTION

As described herein, embodiments of the present invention include methods of forming porous graphene-based structures, and porous graphene-based structures having more uniform porosity than prior art graphene-based structures. The structures as described herein are useful for a wide variety of different applications, including sensing and electronic applications. In particular, when multi-layer porous graphene-based structures as described herein are used as the plates of a supercapacitor, this provides a lightweight and compact form of energy storage that can have a higher energy density than commercially available lithium batteries, for example.

The methods described herein involve direct laser photo-reduction of graphene oxide to form electrically conductive ‘reduced graphene oxide’ (rGO) by two-photon absorption in the graphene oxide using ultrashort (femto-second, fs) pulses of a laser. The inventors have determined that the porosity of the resulting structures, and in particular the uniformity of porosity, can be controlled by adjusting the pulse parameters of the pulsed laser beam.

The resulting porous structures can also be stretchable. Stretching of the porous material causes damage to its atomic structure (breaking of atomic bonds which results in the formation of smaller crystalline domains), leading to degradation of at least some physical properties in the material (including reduced electrical conductivity). However, it is believed that the permanent elastic strain resulting from the laser irradiation leads to healing of defects such as Stone-Wales defects and C₂ vacancies induced by stretching. For example, as described below, in one embodiment the porous structure was formed on a stretchable (e.g., polymer) substrate, and the resulting article is found to be stretchable to at least 150% of its original length without loss of functionality.

Although the porous graphene-based structures are primarily described herein in the context of supercapacitors, it will be apparent to those skilled in the art that the structures are not limited to this application, but can be used in a wide variety of different applications.

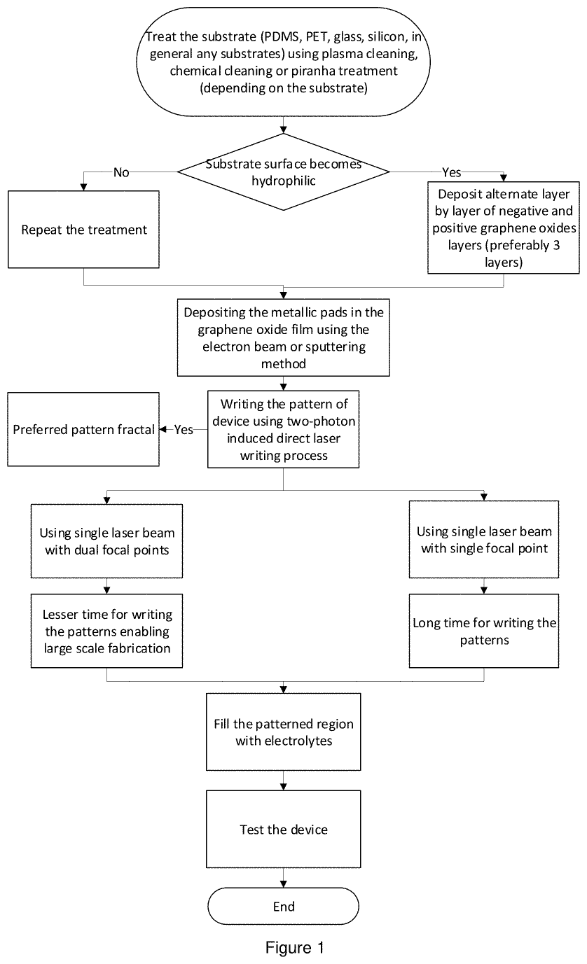

As shown in FIG. 1, a method of forming a porous graphene-based structure begins with a substrate on which the structure will be formed. The substrate may be composed of a rigid material such as silicon, glass, or PET, or may be a flexible material such as a polymer, for example. Moreover, the flexible material may also be stretchable, in which case the resulting porous structures are also flexible, as will be described below. In the described embodiments, the polymer PDMS is used as the substrate material, providing both flexibility and stretchability.

The role of the substrate is to support layers of graphene oxide deposited onto the substrate. In order to ensure that the graphene oxide will adhere to the substrate, it is cleaned prior to deposition of the graphene oxide. In the described embodiments, this cleaning step is performed by plasma treating the substrate surface (for 20 minutes in an Argon plasma using a flow rate of 1-2 SCHF). The plasma treatment can be configured so that the resulting surface is either hydrophobic or hydrophilic. For example, plasmas generated from air, oxygen or nitrogen tend to activate the treated surface, making it hydrophilic, whereas argon or hydrogen plasmas tend to make the surface hydrophobic.

In other embodiments, the cleaning step may alternatively involve chemical cleaning using a solvent such as acetone, methanol, or isopropanol, or a standard cleaning process such as a standard ‘piranha’ cleaning process known to those skilled in the art, for example.

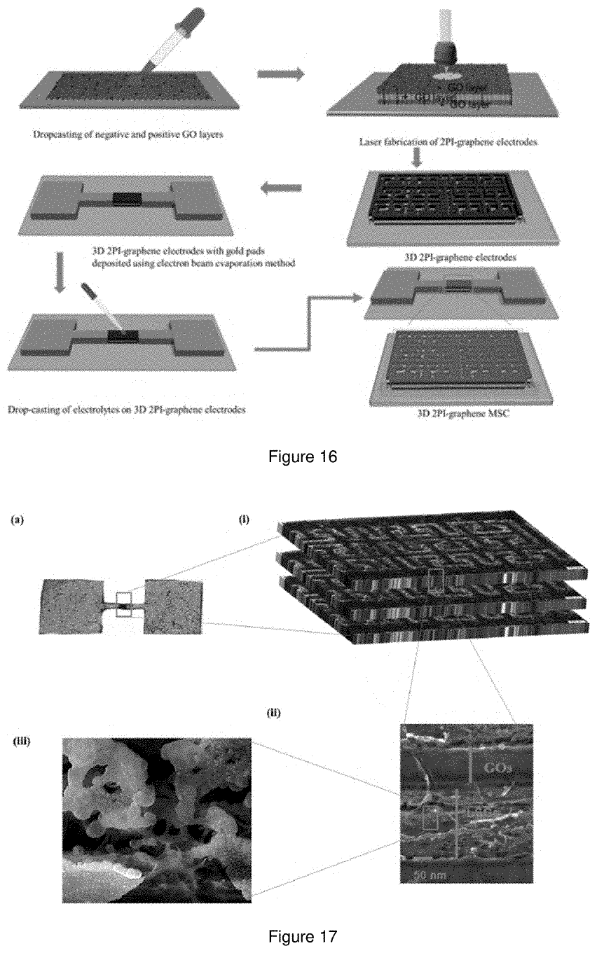

After the cleaning step, one or more layers of graphene oxide are deposited over the substrate, as shown in the top-left part of FIG. 16. This can be done using any suitable deposition technique known to those skilled in the art, including spray coating, drop casting, and vacuum filtration, for example. As known by those skilled in the art, layers or flakes of graphene oxide have either a positive or a negative polarity, and consequently when multiple layers or flakes are deposited onto the surface, they will have alternating polarities, with the polarity of the layer or flake closest to the substrate surface being determined by whether the latter is hydrophobic or hydrophilic. In the described embodiments, the plasma-treated PDMS surface is hydrophilic, and three graphene oxide layers or flakes of alternating polarities are deposited over the hydrophilic plasma-treated PDMS surface.

In order to facilitate electrical connections to the structure, electrically conductive contact pads or electrodes are formed on the graphene oxide using any standard methods known to those skilled in the art, as shown in the middle-left part of FIG. 16. For example, in the described embodiments, this is done by a physical deposition method such as electron-beam evaporation or sputtering of a metallic electrode material.

After the contact pads have been deposited, a desired pattern of conductive material is formed from the graphene oxide layers by direct laser writing using at least one ultrafast (fs) pulsed laser beam to reduce corresponding portions of the graphene oxide layers by two-photon absorption, as shown in the top-right part of FIG. 16. In the described embodiments, a pulsed laser beam having a wavelength of 800 nm and a pulse width of 120 femtoseconds was used in conjunction with a 20× air objective having a numerical aperture (NA) of 0.5. The laser pulse repetition rate was varied between 10 kHz and 80 Mhz to provide respective average laser powers between 25 μW and 30 mW. For the purposes of comparison, a cw CO₂ laser beam of wavelength 10.6 μm was also used to produce some structures.

As will be appreciated by those skilled in the art, essentially any practically achievable pattern can be formed in the graphene oxide, subject to the spatial resolution achievable by the laser irradiation conditions. For example, the pattern may include an interdigitated finger structure or a fractal structure, such as that described in Thekkekara, L. V., and Gu, M., Bioinspired fractal electrodes for solar energy storages, Scientific Reports, 7 (2017). In the described embodiments, a spatial resolution equal to 1 μm was achieved.

In the described embodiments where the reduced graphene oxide regions are used as the plates of a supercapacitor, an electrolyte is added to the patterned region to increase the capacitance between the capacitor plates, as shown in the lower-left part of FIG. 16. In some embodiments, an ionogel is used to provide a solid-state supercapacitor with a non-volatile electrolyte. In other embodiments, ionic liquids, aqueous liquids, or organic liquids and gels known to those skilled in the art may be used as the electrolyte.

The resulting structure constitutes a high capacitance device known in the art as a ‘supercapacitor’. In a commercial device, the structure would be packaged to seal the contents within a hermetic enclosure and to facilitate handling.

The inventors have determined that the porosity of the reduced graphene oxide regions strongly depend upon the characteristics of the ultrashort pulses used to reduce the graphene oxide by two-photon absorption. For example, using a fixed pulse duration and pulse power as described above, the porosity can be tuned by adjusting the pulse repetition rate, as shown schematically in FIG. 2.

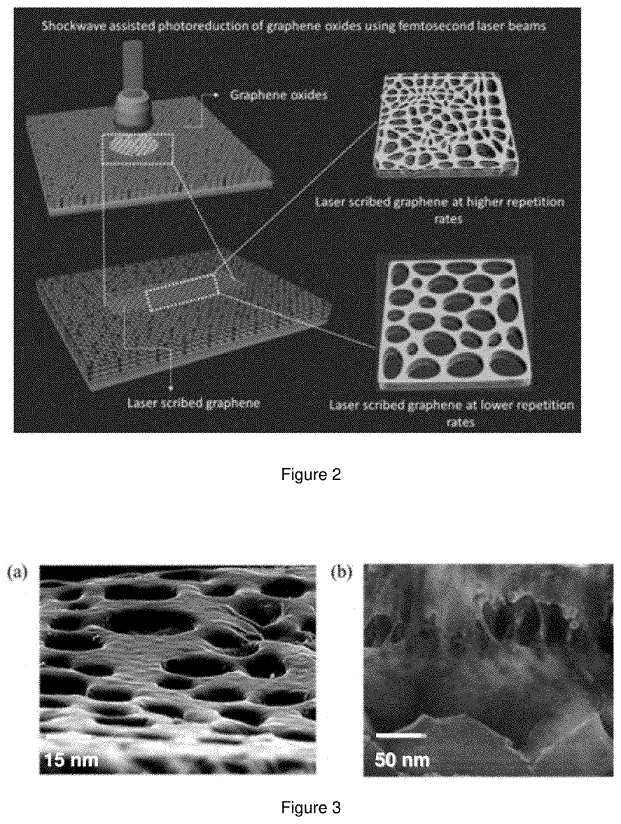

FIG. 3 includes scanning electron microscope images (45° view) of porous reduced graphene oxide layers formed at the highest (a) and a lower (b) pulse repetition rates of 80 MHz and 10 kHz, respectively. As shown in these images, the inventors have determined that both the dimensions of the pores and their centre to centre spacing has an inverse relationship with the laser pulse repetition frequency. That is, the size and spacing between pores decreases with increasing pulse frequency. Moreover, the uniformity of the spatial distribution of pores also improves with increasing pulse frequency.

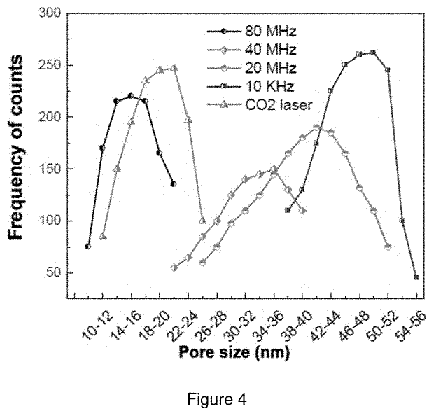

For example, FIG. 4 is a graph showing the statistical distributions of pore diameters for laser pulse frequencies of 10 kHz, 20 MHz, 40 MHz, and 80 MHz, and the cw CO₂ laser as described above. Clearly, for repetition frequencies in the megahertz range, the widths of the statistical distributions decreases significantly with increasing repetition frequency, resulting in a more uniform (i.e., narrower) distribution of pore diameters, with the narrowest statistical distribution resulting from laser reduction of graphene oxide at the highest available pulse repetition frequency of 80 MHz, which produces pores with an average diameter of 14 to 16 nm. Although irradiation with a cw CO₂ laser beam at 10.6 microns produces an average pore diameter of 18-20 nm, the use of a cw laser rather than a pulsed laser beam generates significant heating of the graphene oxide, which has the effect of degrading the spatial resolution of direct writing, in this example to about 80 μm.

The inventors have further determined that the reduction of the graphene oxide at least partially includes a photothermal effect, a photochemical effect and/or a combination thereof. Indeed, in some embodiments the influence of the photothermal and/or photochemical effect is tunable by adjusting the laser pulse repetition rate, and this will be described in more detail below.

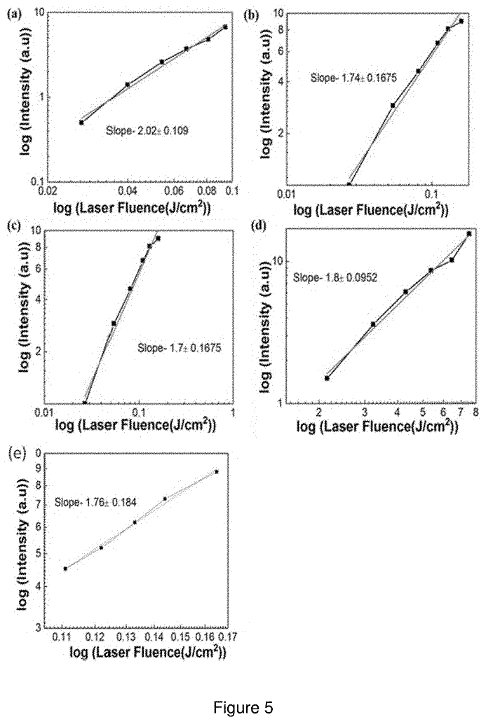

The following embodiments (FIGS. 5 to 12) include samples prepared using concentrated graphene oxides (4 mg/ml) diluted to a molar concentration of 1.3 mg/ml. Two ml of the diluted graphene oxide was drop-cast on a glass substrate and dried at 60° C. using a heat plate in the atmospheric conditions. The thickness of the graphene oxide films are around 3, 7 and 10 μm.

In one example, the photochemical effect includes a photoacoustic effect.

FIGS. 5(a) to (e) are graphs (logarithmic scale) of intensity and laser fluence for decreasing pulse repetition rates: 80 MHz, 40 MHz, 20 Mz, 10 kHz, and 5 kHz, respectively. Experimental results are shown as black squares, where a line of best fit is incorporated in grey. The slope of the line of best fit is indicated on each figure. In this example, a 100× oil objective with a 1.4 NA was used at a wavelength of 800 nm. As shown, the influence of multi-photon (two-photon) absorption reduces as repetition rates decrease. It is understood that the two-photon absorption coefficient may be derived from slope of laser fluence graph. Specifically, a slope >2 indicates the involvement of multiphoton absorption, and a slope <2 indicates a reduction in the influence of two-photon absorption and the increasing influence of other factors, including photoacoustic effects. Thus, the inventors have determined that the two-photon absorption which induces the photothermal effect may be reduced with a decrease in pulse repetition rate.

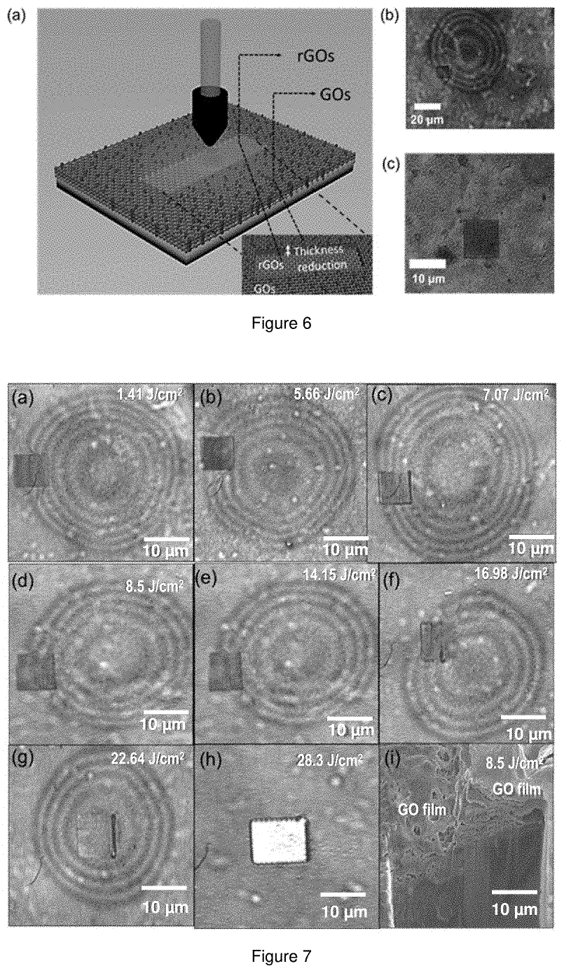

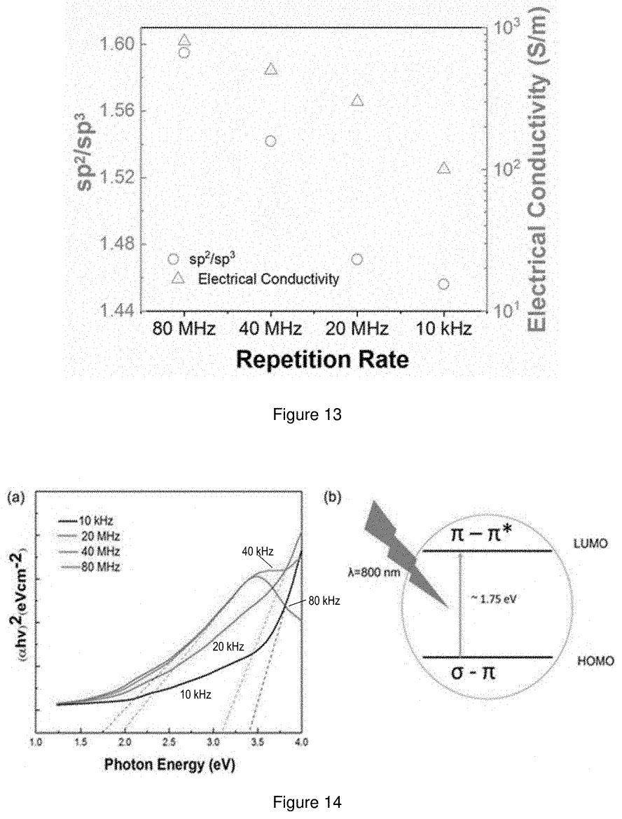

For instance, FIG. 6(a) is a schematic of the thickness reduction in the abovementioned graphene oxide film as it is reduced to rGO using ultrashort pulses of a laser. FIG. 6(b) shows CCD camera images of transient stationary acoustic waves during pulsed laser beam exposure with a pulse repetition rate of 5 kHz. In particular, a pulsed laser beam having a wavelength of 800 nm and a pulse width of 120 femtoseconds was used in conjunction with a 100× oil objective having a numerical aperture (NA) of 1.4. FIG. 6(c) is a CCD camera image of the region shown in FIG. 13(b) subsequent to laser beam exposure, including the resultant rGO thin film.

FIGS. 7(a) to 7(h) include CCD camera images of transient stationary acoustic waves in graphene oxide films during exposure to ultrashort pulses, as described in the embodiment above, with varying laser fluence, and a scan stage speed of 10 μm/s. The reduced graphene oxide thickness reduction due to the acoustic wave induced by the photochemical mechanism is shown in FIG. 7(f).

The inventors have determined that the observed wave velocities of the acoustic waves in FIGS. 7(a) to 7(h) are consistent with laser-induced acoustic standing waves (Kinsler, L. E.; Frey, A. R.; Coppens, A. B.; Sanders, J. V. Fundamentals of Acoustics, 4th Edition, by Lawrence E. Kinsler, Austin R. Frey, Alan B. Coppens, James V. Sanders, pp. 560. ISBN 0-471-84789-5. Wiley-VCH, December 1999, 560). That is, the reduction of the graphene oxide in these examples includes, at least in part, a photochemical effect including a photoacoustic effect observable as laser induced transient acoustic waves. Indeed, the inventors have inferred that the transitory behaviour of the acoustic waves may be attributed to the chemical breakdown of the graphene oxide atomic structure, including breakage of OH, COO and COOH groups, leading to the release of water molecules, and resultant structural rearrangement of the film.

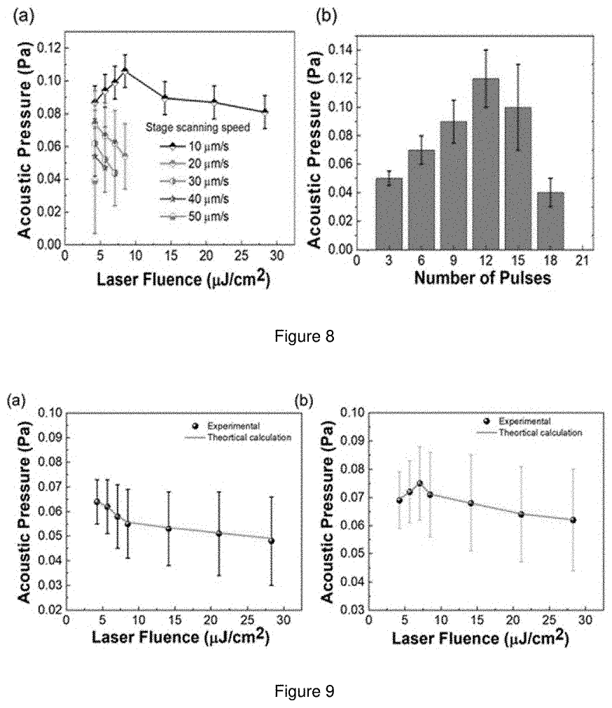

The inventors have further noted that in some examples peak acoustic pressure decreases as laser fluence and laser scanning speed increases. FIG. 8(a) includes the calculated photoacoustic pressure at different laser fluences for scanning speeds between 10 and 50 μm/s, and a pulse repetition rate of 5 kHz. In this example, graphene oxide films of 7 μm thickness were exposed to ultrashort pulses of a laser. Acoustic peak pressure was calculated from observed wave velocity, Us, using equation (1) and Table 1:

$$P = {ρ}_{0} {U}_{s} \frac{{U}_{s} - {c}_{0}}{1.99} \qquad ( 1 )$$

TABLE 1
Material properties of graphene oxides (Veysset, D.; Pezeril, T.; Kooi, S.;
Bulou, A.; Nelson, K. A. Applied Physics Letters 2015, 106, (16), 161902.)

| αₛ | ρ₀ | L | Cₚ | κ | | | c₀ | Tₘ | Tₑᵥ |
|---|---|---|---|---|---|---|---|---|---|
| (m²/s) | (kg/m³) | (J/kg) | (J/kgK) | (μm⁻¹) | γ | R | (m/s) | (K) | (K) |
| 1.54 × 10⁻³ | 1800 | 64.7 × 10³ | 710 | 0.1211 | 0.9998 | 8.314 | 30 | 1473 | 4773 |

FIG. 8(b) is a graph indicating the acoustic pressure according to different numbers of ultrashort laser pulses, at a laser fluence of 10 μJ/cm² and scanning speed of 10 μm/s. In this example, acoustic pressure was maximised between 9 and 15 pulses, and more specifically at 12 pulses, between opening and closing of the laser shutter.

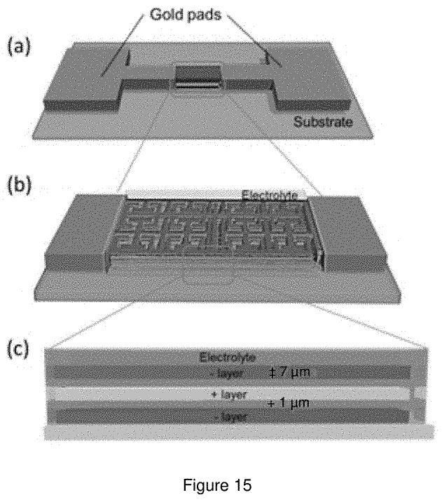

FIG. 9(a) and FIG. 9(b) are graphs including experimental (black circles) and theoretical (red line) acoustic pressures in graphene oxides films of thicknesses 3 μm and 5 μm, respectively, exposed to ultrashort pulses of laser. Similar to FIG. 15(a), the repetition rate of the laser pulses was 5 kHz, with wavelength 800 nm. As shown in this example, acoustic pressure appears to decrease with film thickness and laser fluence.

The inventors have determined that the respective photothermal and photochemical effects are at least partially tunable using the repetition rate of the ultrashort pulses. This may in turn lead to tunability of physical properties of the reduced graphene oxide in accordance with, for example, a dominant reduction mechanism (e.g. a photothermal effect or a photochemical effect). For example, at lower pulse repetition rates (e.g. 5 kHz and 10 kHz), the influence of laser induced transient acoustic waves in the reduction of graphene oxide can in turn influence physical properties of the resultant rGO such as electrical conductivity, refractive indices and linewidth. At higher pulse repetition rates (e.g. 80 MHz, 40 MHz, etc), increased surface temperature is indicative of a more dominant photothermal effect in the reduction process, which in turn can influence the physical properties of the resultant rGO.

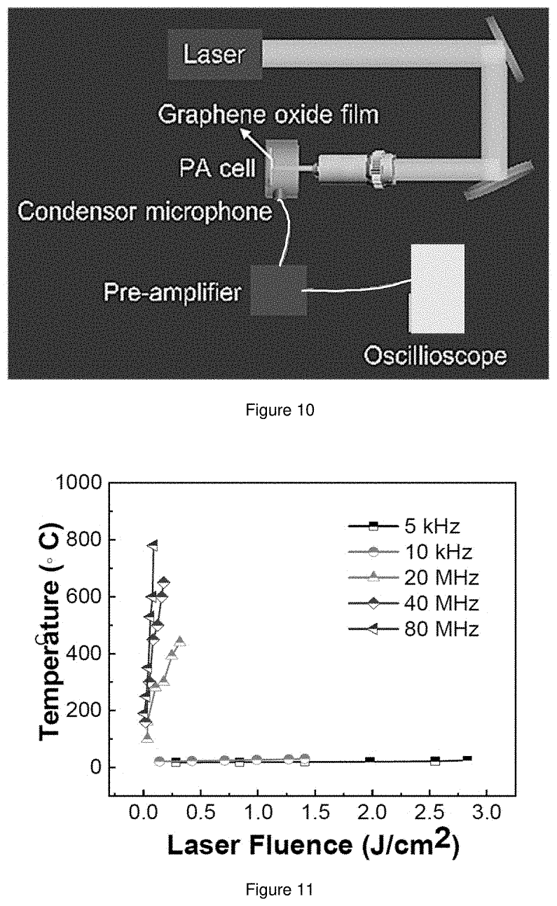

A schematic of the experimental setup for observations shown in FIGS. 5, 11 and 12 is provided in FIG. 10. In this embodiment, a laser capable of ultrafast pulses of laser radiation was included, having a wavelength of 800 nm, and pulse width of 120 fs in conjunction with an objective having a numerical aperture (NA) of 1.4. Pulse repetition rate was varied from 5 kHz to 80 MHz. A photoacoustic resonant cell housed the graphene oxide sample. A condenser microphone of 6 mm, capable of measuring broadband frequency between 20 Hz and 20 kHz with a sensitivity of 42 dB, was positioned 3 mm from the sample. Photoacoustic signals were detected and amplified using a preamplifier. The signals were recorded at a sampling rate of 10 GS/s and analysed using an oscilloscope.

FIG. 11 is a graph showing that pulse repetition rate influences surface temperature during exposure of the graphene oxide film to pulses of laser radiation. As shown in this graph, surface temperature is heavily influenced by pulse repetition rate, such that a reduction from 800° C. to 30° C. is observable as pulse repetition rates are reduced from 80 MHz to 10 kHz. Surface temperature is determined by the inventors to be indicative of a dominant photoreduction effect. For example, higher temperatures are inferred to be indicative of a dominant photothermal effect, that is, two-photon absorption.

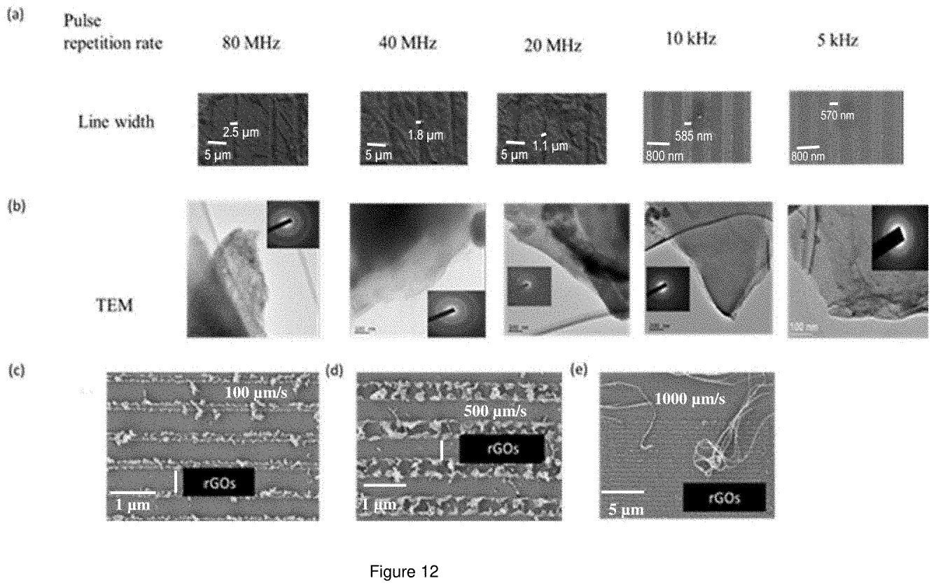

Laser fabricated line patterns obtained using a 100× objective with decreasing pulse repetition rates exhibit a decreasing line width, as shown in FIG. 12(a). The inventors have determined this is indicative of a reduction in the influence of the photothermal process, as the heat affected surfaces decrease with lower pulse repetition rates. Transmission electron microscopy (TEM) images of the reduced graphene oxide films using different pulse repetition rates are shown in FIG. 12(b). In these images, the reduced graphene oxide films exhibit a semimetal state with a polycrystalline behaviour, and smaller crystalline phases are visible from the highlighted diffraction profiles. In addition, higher laser scan speeds appear to lead to the ablation of the resulting film pattern (FIG. 12(c)).

FIG. 13 is a graph showing both the sp²/sp³ ratio (circular data symbols) of the reduced graphene oxide regions as measured by XPS measurements and the electrical conductivity (square data symbols) of those regions as a function of pulsed laser repetition frequency. The XPS data shows that the sp²/sp³ ratio increases with increasing pulse repetition frequency, suggesting a reduction in defects with increasing frequency. Similarly, the electrical conductivity of the reduced graphene oxide regions increases dramatically (note the logarithmic scale) with increasing pulse frequency. These data indicate that, for electronic applications, the electronic performance of the devices increases with increasing pulsed laser frequency, at least within the parameter ranges described herein.

The optical bandgap in these embodiments was experimentally estimated for the reduced graphene oxide film under optimum laser beam fluence at different laser pulse repetition rates, as shown in the Tauc plot at FIG. 14(a). In particular, the optical gap is estimated as the y-intercept of the best fitting Tauc equation, which for a repetition rate of 80 MHz, is approximately 1.75 eV as shown in FIG. 14(b). The decrease in bandgap in accordance with decreasing pulse repetition rates is consistent with the increase in sp2/sp3 noted in FIG. 13.

In view of the above, the inventors have determined that transient stationary acoustic waves contribute to photochemical breakdown of graphene oxide at lower pulse repetition rates. Additionally, the photoacoustic energy initiates crystallisation of the reduced graphene oxide film. Conversely, higher temperatures generated during higher pulse repetition rates influence the photoreduction (i.e. via a photothermal mechanism). Additionally, as discussed above, laser fluence and mechanical vibrations due to scanning speeds, also influence acoustic pressure in the photoacoustic effect.

### Supercapacitor Applications

As described above, the nanoscale porous structures described herein are particularly well-suited for energy storage. In particular, a supercapacitor can be formed from the structure described above by adding an electrolyte to the patterned region of the device to increase the capacitance between the capacitor plates. In some embodiments, an ionogel is used as the electrolyte. In the described embodiments, 1-2 μl of ionogel is added to the reduced graphene oxide electrodes, and the specific ionogel used is a mixture of fumed silica and 1-Butyl-3-methylimidazolium bis(trifluoromethylsulfonyl)imide in the ratio 0.03:1.

The capacitor plates can be formed within the plane of each reduced graphene oxide layer (by suitable patterning, such as interdigitated finger structures known to those skilled in the art, for example), in addition to between adjacent reduced graphene oxide layers. For example, FIG. 15 is a schematic diagram showing porous capacitor plate regions formed from a stack of three graphene oxide layers, with enlarged views showing the capacitive storage of positive ions and negative ions in corresponding regions of adjacent layers. FIG. 16 provides a schematic of the step by step formation of 3D supercapacitors using laser beam irradiation in graphene oxide.

FIG. 17(a) is an optical image of a supercapacitors device formed as described above, with the majority of the device being the two contact pads for making electrical contacts to the device, and the functional structure and capacitor plates of the device being located in the small region between the two contact pads, as highlighted by the rectangular box in the Figure. FIG. 17(i) is a schematic representation of the stack of three patterned layers of the structure, which define the capacitor plates in the form of a meandering, and substantially space filling path or track.

FIG. 17(ii) is a plan view electron microscope image of a portion of the device, showing portions of the rGO path formed by the scanned laser beam and remaining graphene oxide (GO) regions that were not exposed to the laser beam.

FIG. 17(iii) is a higher magnification electron microscope image showing the complex and porous structure of the reduced graphene oxide regions. As will be appreciated by those skilled in the art, this structure provides these regions with a relatively high surface area, which will improve the capacitance of the supercapacitor (and the performance of a sensor formed using the porous surface as a functionalized sensing surface, for example).

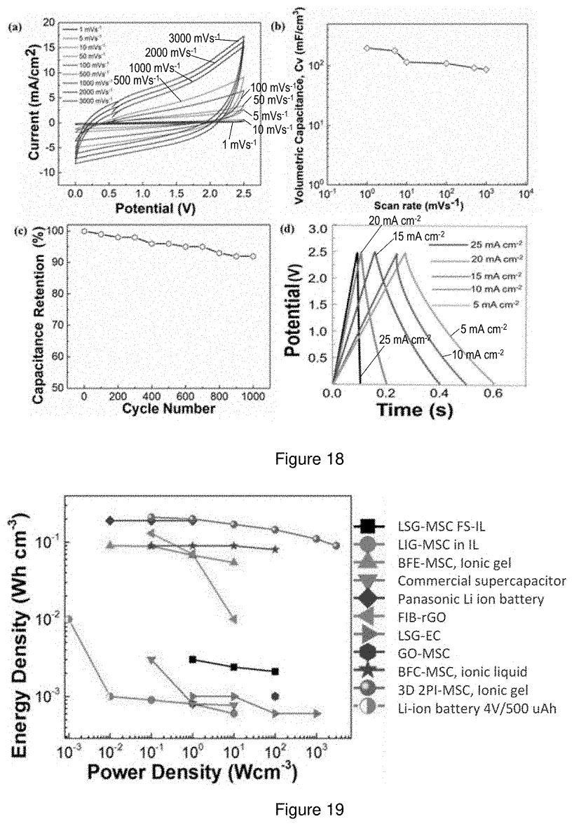

FIG. 18 includes four graphs characterising the performance of supercapacitors produced by the method described above. FIG. 18(a) is a graph of current density as a function of applied voltage for different voltage scan rates of 1, 5, 19, 50, 100, 500, 1000, 2000 and 3000 V s⁻¹. These measurements were used to calculate the volumetric capacitance of the supercapacitors as a function of voltage scan rate, as shown in FIG. 18(b). It can be seen that the performance is stable after the initial decrease contributed from the stabilising of the electrolyte ions at low scan rates of cyclic voltametry. In addition, the results show that stability of the performance of the supercapacitor does not vary significantly as higher voltages are applied.

In order to investigate the reliability of the supercapacitors described herein, the stability of the device capacitance was measured as a function of the number of charge-discharge cycles. As shown in FIG. 18(c), the capacitance does decrease as a function of charge-discharge cycle, but the decrease is relatively slow, being only a few percent after 1000 cycles.

Finally, FIG. 18(d) is a graph showing galvanic charge-discharge curves of the supercapacitors at different current densities of 5, 10, 15, 20, and 25 mA cm−2 having nearly triangular behaviour with an internal drop of 0.1 V for 10 charge-discharge cycles. This shows that the charge time of the supercapacitor decreases as the current density increases. Further, this also shows that supercapacitor performance stability remains constant with low internal resistance.

The supercapacitors described herein are not only compact and lightweight, but also exceed the energy density of other energy storage technologies, including lithium batteries. FIG. 19 is a Ragone plot showing the energy density and power density parameters space for a variety of different energy storage technologies and devices, including lithium batteries and prior art reduced graphene oxide capacitors and commercially available supercapacitors. It is apparent from the plot that the supercapacitors described herein have a higher energy density and power density than any of these prior art devices and technologies.

As described above, an additional capability of the supercapacitors and other porous structures described herein is that they can be formed on stretchable substrates to provide stretchable porous structures.

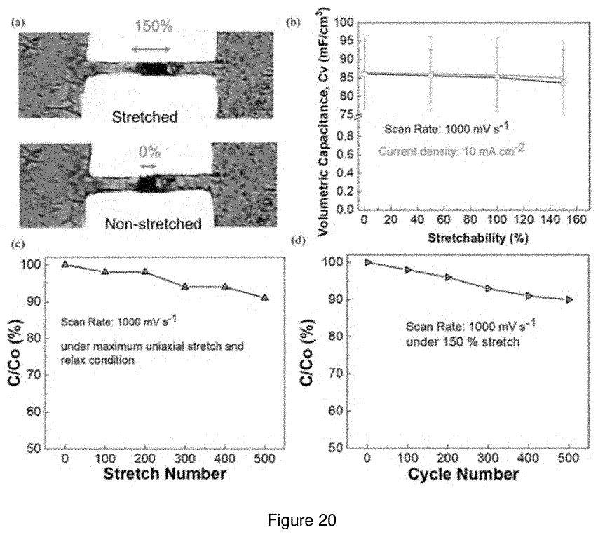

FIG. 20(a) includes optical microscope images of a stretchable supercapacitor structure and its electrodes in stretched and unstretched configurations, wherein a supercapacitors structure having an original length of 1.0 mm is stretched to a length of 2.5 mm; i.e., to 250% of the original length, or an increase of 150%.

FIG. 20(b) is a graph of the volumetric capacitance of the stretchable supercapacitor structure as a function of the percentage length increase from 0% to 150%, as measured by (i) cyclic voltammetry for a voltage scan rate of 1000 mV s⁻¹, and (ii) by galvanostatic charge-discharge measurements at a current density of 10 mA cm⁻², demonstrating that the volumetric capacitance is essentially unaffected by stretching.

FIG. 20(c) is a graph showing the decrease of capacitance as a function of the number of stretches to the maximum stretch increase of 150%, indicating that the capacitance decreases by about 10% after 500 stretch cycles. FIG. 20(d) is a graph showing the decrease of capacitance as a function of the number of voltage cycles for a statically stretchable capacitor stretched by an additional 150% of its original length, indicating a similar decrease of capacitance by about 10% after 500 voltage cycles.

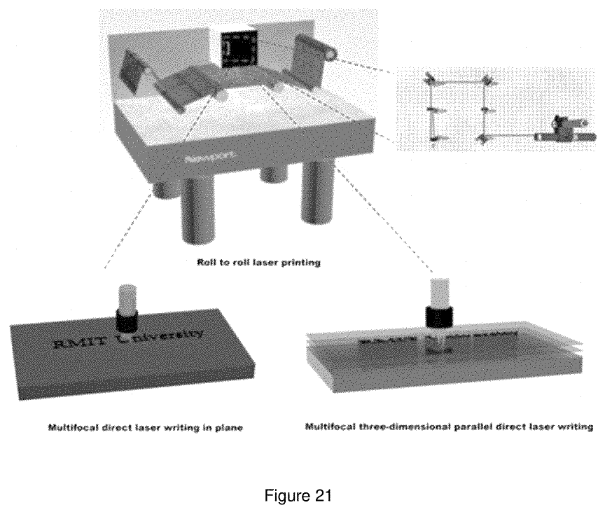

The direct laser writing method described herein is well-suited for industrial scale production, where processing time is an important factor. FIG. 21 is a schematic illustration of a roll to roll laser printing apparatus wherein an input roll of a continuous sheet of a flexible and wearable substrate material coated with graphene oxide layers is loaded into the apparatus, and fed to an output role via a pulsed laser to provide continuous photo-induced reduction of patterned regions of the graphene oxide layers up to 4×10 cm². In order to reduce the processing time, multiple laser beams can be used to simultaneously reduce regions in parallel. These regions can be laterally spaced so that different regions of each graphene oxide layer can be reduced in parallel (as shown in the left image of FIG. 21), and/or can be focused onto different graphene oxide layers so that multiple layers are reduced in parallel (as shown in the lower-right image of FIG. 21). For example, a multi-focal array of 10×10 focal spots can be used to simultaneously reduce up to 200 regions of graphene oxide, and in the described embodiment, 100 circular regions were reduced. With the pulsed laser described above, 40 laser pulses it is found sufficient to reduce each region. Using a laser scanning speed of 100 μm/s, it would take 40 minutes to reduce a plan view area of 100 mm² using a single focal spot, but only 15 seconds using the array of focal spots. Similarly, an area of 40 cm² would take three months to expose using a single focal spot, but only 4.6 hours using the multifocal array.

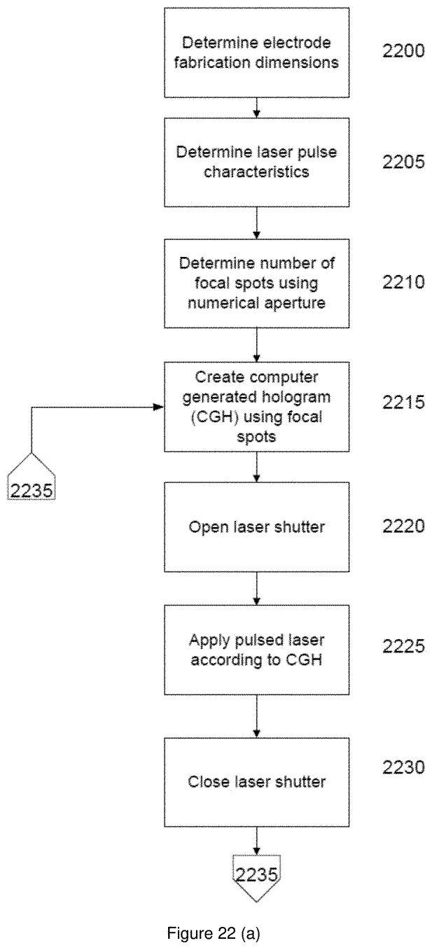

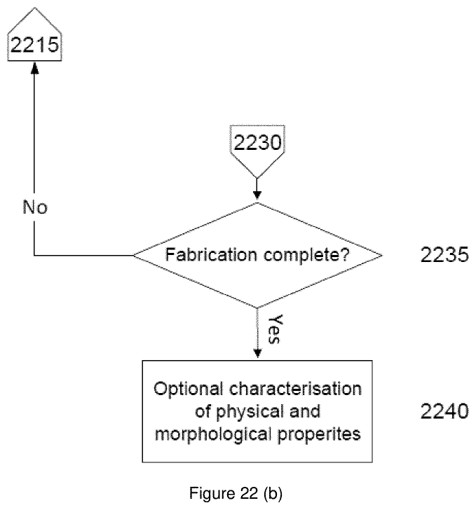

FIG. 22(a) and (b) is an example of a method for generating a hologram for multifocal fabrication of two-photon induced, patterned regions of reduced graphene oxide. This method may be used with any suitable laser printing apparatus, including for the fabrication of large-scale reduced graphene supercapacitors as described with reference to FIG. 21. The inventors have determined that this exemplary method may be used for fabrication of large structures beyond, for example, limitations such as the diffraction limit of light, and stitching errors generating during continuous simple to complex structure fabrication. In particular, to increase fabrication speed, the method considers numerical aperture of the objective, which in turn influences the number of multifocal spots, scanning movement speed and delays, and shutter delay in opening and closing the laser beam.

At step 2200, the method includes determining electrode fabrication dimensions for the supercapacitor. This may be achieved in any suitable manner and may include determining manufacturing limitations of the laser. For instance, an overall dimension of supercapacitor electrode of 1 mm³ is in this example determined by scanning stage limitations of the laser (that is, 1.5 mm), where scanning stage minimum incremental movement is 0.3 μm.

At step 2205, laser pulse characteristics are determined, including wavelength, width of the laser pulse, and pulse repetition rate. In this example, ultrashort (120 fs pulse width) pulses of laser are used, at a wavelength of 800 nm, and pulse repetition rate of 5 kHz.

The number of focal spots is determined at step 2210 using the numerical aperture of the objective of the laser. As mentioned above, increasing the number of focal spots results in a decrease in fabrication time. A computer generated hologram (CGH) is created at step 2215 using the number of focal spots determined at step 2210. This may be achieved in any suitable manner, and in the preferred embodiment the CGH is created in accordance with Debye vectorial theory by modification of methods and algorithms known in the art.

The laser shutter is opened at step 2220. At step 2225 the ultrashort pulsed laser is applied to regions of the graphene oxide at the multi-focal spots in accordance with the calculated CGH, including moving the scanning stage across the exposed multifocal points to form continuous lines. In this example the laser fluence of the beam is typically between 0.1 and 0.5 J/cm³.

At step 2230 the laser beam shutter is closed. In this example, typically the shutter closes up to 0.3 ms after opening at step 2220. If the entire structure fabrication is not complete at 2235, the CGH at step 2215 is updated for subsequent, consecutive scanning stage movement, and steps 2215 to 2235 are repeated. Once the entire structure is fabricated, optionally at step 2240, characterisation of the fabricated structures (such as physical and morphological properties) may be obtained under fabrication conditions.

As described above, the method of forming porous graphene-based structures described above is able to form patterned porous regions of reduced graphene oxide or graphene in stacked layers with uniform distributions of nanometre scale pores. By appropriate selection of the pulsed laser irradiation conditions (in the embodiment described above, being an 800 nm pulsed laser with a pulse width of 120 fs and a repetition rate of 80 MHz, a laser fluence of 0.18 mJ cm⁻², and a 20× objective, 0.6 NA optics), pores with an average diameter as small as 20 nm and electrodes having an electrical conductivity of 10³ Sm⁻¹ and a width down to 4 μm and an inter-electrode spacing down to 1 μm can be formed (this high spatial resolution resulting from the use of two-photon absorption). In addition, with higher NAs the spatial resolution can be reduced down to 550 nm. Using a PDMS substrate, the porous structures described herein are stretchable to 150% of the original length and are flexible to angles up to 60°. By using the laser to reduce regions of a stack of multiple layers of graphene oxide, three-dimensional porous structures are formed. Moreover, the influence of two-photon reduction and photothermal effects in the reduction of rGO can be reduced with a decrease in pulse repetition rates. At lower pulse repetition rates, the effect of photochemical, including photoacoustic, reduction in the formation of rGO from graphene oxide increases. Accordingly, selection of a dominate photoreduction effect (photothermal vs photochemical) facilitates tuning of physical and morphological characteristics of the resultant rGO.

The method can be used to form supercapacitors with better performance than prior art technologies and devices, including commercially available supercapacitors and lithium batteries.

Many modifications will be apparent to those skilled in the art without departing from the scope of the present invention.

1. A method of forming a porous graphene-based structure, including directing a laser beam onto one or more layers of graphene oxide to reduce at least a portion of the graphene oxide, wherein the laser beam consists of ultrafast femtosecond (fs) pulses of laser radiation to cause reduction of at least a portion of the graphene oxide by two-photon absorption and form one or more respective porous layers of reduced graphene oxide (rGO) having substantially uniform porosity.

2. (canceled)

3. The method of claim 1, wherein the reduction of the graphene oxide at least partially includes at least one of a photothermal effect and a photochemical effect.

4. The method of claim 3, wherein the two-photon absorption induces the photothermal effect.

5. The method of claim 3, wherein the photochemical effect includes a photoacoustic effect.

6. The method of claim 3, wherein at least one of the photothermal and the photochemical effect are at least partially tunable using a repetition rate of the pulses.

7. The method of claim 1, wherein the uniform porosity provides a substantially uniform spatial distribution and/or a substantially uniform statistical distribution of pores.

8. (canceled)

9. The method of claim 1, wherein the average pore size is less than 20 nm, and preferably less than 15 nm.

10. The method of claim 1, wherein the laser beam has a wavelength of about 800 nm, and the pulses have a width of about 120 fs and a repetition rate of 80 MHz to provide an average power of about 30 mW and a laser fluence of about 0.2 mJ cm⁻².

11. The method of claim 1, wherein the laser beam is directed onto the one or more layers in accordance with a predetermined pattern such that the resulting porous layers are correspondingly patterned.

12. The method of claim 1, including forming a supercapacitor from the structure, wherein the porous layers form electrodes of the supercapacitor.

13. The method of claim 12, wherein the supercapacitor has an energy density of at least 0.1 Wh cm⁻³.

14. The method of claim 12, wherein the supercapacitor has a power density of at least 10³ W cm⁻³.

15. The method of claim 12, wherein the supercapacitor has a volumetric capacitance of about 10² mF cm⁻³.

16. The method of claim 1, including depositing the layers of graphene oxide on a substrate.

17. The method of claim 1, wherein the porous layers are stretchable by at least 10%, preferably at least 50%, more preferably at least 100%, and even more preferably at least 150%.

18. (canceled)

19. The method of claim 1, wherein the one or more layers are a plurality of layers, and the porous layers have a spacing of about 1 μm.

20. A porous structure formed by the method of claim 1.

21. A porous graphene-based structure, including porous layers of reduced graphene oxide (rGO) having substantially uniform porosity.

22. The porous graphene-based structure of claim 21, wherein the uniform porosity provides a substantially uniform spatial and/or substantially uniform distribution of pores.

23. (canceled)

24. The porous graphene-based structure of claim 21, wherein the average pore size less than 20 nm, and preferably less than 15 nm.
